(19) United States
(12) Patent Application Publication
(10) Pub. No.: US 2014/0151446 A1
(43) Pub. Date: Jun. 5, 2014

(54) System and Method for Asset Management

(71) Applicant: Don R. Bovell, Miami, FL (US)

(72) Inventor: Don R. Bovell, Miami, FL (US)

(21) Appl. No.: 14/090,343

(22) Filed: Nov. 26, 2013

Related U.S. Application Data
(60) Provisional application No. 61/732,338, filed on Dec. 1, 2012.

(51) Int. Cl. G06Q 10/06

(52) U.S. Cl. CPC G06Q 10/06
USPC 235/375

(57) ABSTRACT

A system for asset management comprising a code assigned to an asset, an encrypted geo-coded barcode, a mobile device for scanning and transmitting data from the encrypted, geo-coded barcode, and a cloud based computer system that receives barcodes scan data from the mobile device and generates log of barcode scans. A method for asset management is described wherein the method comprises assigning a code to an asset, attaching an encrypted and geo-codes barcode to the asset, scanning the barcode with a mobile device, and transmitting the barcode scan information from the mobile device to a cloud based computer server system and generating a log of barcode scans.

### RELATED APPLICATIONS

This application claims priority to U.S. Provisional Application No. 61/732,338 filed Dec. 1, 2012. The entire contents of the above application are hereby incorporated by reference as though fully set forth herein.

### FIELD

The present invention relates to the field of asset management. More specifically, the present invention relates to system and method of asset management that provides independent verification that inspections and other related scheduled tasks are carried out according to predefined parameters.

### BACKGROUND

Asset management accountability is an ever-increasing problem that companies face today. Making sure that a person turns up to perform assigned duties on time and at the correct location can be a challenge. This is especially true using mobile devices, where the person can state they are somewhere they're supposed to be, when, in fact, they are not. Thus, there exists a need for a system and a method of asset management wherein independent verification is provided to predefined recipients (i.e. managers) that the tasks, inspections, other related tasks, etc. are being carried out by the correct person at the correct location and at the prescribed time.

Further, there exists a need for a system and method of tracking assets that does not rely on the integrity of the person assigned to the task to initiate a communication with a centralized station. Additionally, there is a need to compensate for the fact that a mobile device used by a person assigned to the task may not always have wireless access and is unable to transmit confirmation to the centralized station.

### PRIOR ART

There have been many attempts in the prior art to address these challenges such as U.S. Pat. No. 8,019,622 to Kaboff et. al. which discloses a server system in communication with a plurality of mobile devices for health care providers as well as U.S. Patent Application No. 2010/30265155 to Wible et. al. which discloses a method using portable devices to scan identification tags on assets and then generating and transmitting a message about adding or removing the asset. However, these attempts fall short in that the systems use only the mobile devices built-in GPS to signal where the employee is and relies on the integrity of the employee to “phone” or “text in” to a central station. The GPS found in most such enabled devices are not 100% accurate in terms of reporting an exact location. While there are several reasons for this that are well known in the field, it is sufficed to point out that differences of up to several hundred yards may be observed, which would then render the “reported” latitude and longitude ineffective and perhaps even useless in many situations.

The present invention seeks to address this shortcoming by using encrypted, geo coded bar codes that must be scanned by the assigned person, which then in turn via a mobile application, allows for a server to communicate with predefined recipients, such as management, to report whether the person is indeed on location at the correct time. This is vital as it places the employee at the location of the asset. For example, a shopping mall or center which has several stores side by side within a 100 foot range—merely relying on a mobile phones GPS latitude and longitude alone could place that employee in any one of the stores within that range. In the present invention, the barcode that is scanned actually places the employee at the specified location. Further, the mobile application can store the information on the device used to scan the barcode, thereby serving as a “back-up” in the event that wireless communication is not available at the time of the scan. When communication is available again, the data is automatically uploaded to the server or centralized station.

### BRIEF SUMMARY OF THE INVENTION

It is the object of the present invention to address several challenges in previous attempts for asset management and accountability. The preferred embodiment of the present invention is a system for asset management comprising a code assigned to an asset, an encrypted geo-coded barcode, a mobile device for scanning and transmitting data from the encrypted, geo-coded barcode, and a cloud based computer system that receives barcodes scan data from the mobile device and generates log of barcode scans. Management or other individuals are able to determine tolerance time periods in advance in which the code assigned to the asset is made inactive until that specific time period. When the employee or other designated individual scans the barcode an alert message may be generated to certain predetermined individuals. Further, an different alert can be generated if the barcode is scanned outside the predetermined tolerance time period.

In another embodiment of the present invention, the system may further comprise a mobile application that is integrated with certain software applications to allow reports to be generated from the log of barcode scans. The mobile application can store the log of barcode scans independent from the cloud based server system such that if the mobile device is unable to transmit the barcode scan at the time of scanning, the mobile application stores and later transmits the scan to the cloud based computer system.

For the purposes of the present invention, the asset is assigned a code based on the specific function of the asset. An “asset” for the purposes of this invention is defined as either a piece of equipment, a person or patient, a worksite, or an assigned activity. The functions of the asset include but are not limited to inspections, check ins, check outs, personnel tracking, patient monitoring, service interval monitoring, and activity monitoring.

The encrypted, geo-coded barcode may be implemented in any number of formats, including but not limited to, near field communication (NFC) tags, quick response (QR) tags, radio frequency identification tags (RFID) or any other tag suitable for encryption and subsequent scanning.

In a second embodiment of the present invention, a method for asset management is described wherein the method comprises assigning a code to an asset, attaching an encrypted and geo-coded barcode to the asset, scanning the barcode with a mobile device, and transmitting the barcode scan information from the mobile device to a cloud based computer server system and generating a log of barcode scans.

The method may further comprise generation of alert messages to predetermined recipients upon scanning, such as management. Management or others may establish a predetermined tolerance time period and if the barcode is not scanned within that time period, an alert message is sent to management or other predetermined recipients.

The method may further comprise using a mobile application to capture scans as well as integrate with software to generate reports from the log of barcode scans. The mobile application may capture scan information independent of the cloud based server, such that if the mobile device is unable to communicate with the cloud based server, the mobile application can store and transmit it to the server at a later time.

For the purposes of the present invention, the asset is assigned a code based on the specific function of the asset. An “asset” for the purposes of this invention is defined as either a piece of equipment, a person, a worksite, or an assigned activity. The functions of the asset include but are not limited to inspections, check ins, check outs, personnel tracking, patient monitoring, service interval monitoring, and activity monitoring.

The encrypted, geo-coded barcode may be implemented in any number of formats, including but not limited to, near field communication (NFC) tags, quick response (QR) tags, radio frequency identification tags (RFID) or any other tag suitable for encryption and subsequent scanning.

Essentially, these tags once programmed by management and printed out and placed on the asset in question, must then be scanned by the assigned employee at the correct time and location. Thus, the present invention is able to provide independent verification to management that inspections and other related scheduled tasks are being carried out by the correct employee at the correct location at the prescribed time. The information is encrypted and kept on the cloud based computer server system, thus requiring no local download. Employees and/or individual assigned to the asset are also entered and assigned a scanning schedule.

The server will keep a log of these scans and will be able to independently confirm to the customer or other pertinent individuals, whether or not the asset scans are being performed on time, by who and at what location. Because the tag has been previously geo-coded, the location scanned from must match that as previously entered when the asset was created. Because a schedule has been created with an assigned individual, if the server does not receive an appropriate scan or if the scan is late, then messages will be sent to the predetermined recipients. Additionally, the mobile application provides for easy and seamless integration with other software applications and historical reports may be printed at any time by the management and/or may be downloaded to be further analyzed as needed.

The mobile App not only serves to validate security, which is vital to meet certain government security requirements (such as HIPPA in the United States), but also, very importantly, to capture the codes scanned and store them, in the case that the device is off-line or there is a communication issue such as being in a building where wireless reception (wifi or cellular) is poor or non-existent. These scanned codes are then uploaded to the server as reception returns, automatically.

Examples of the asset and function of the asset are described further below in the detailed description in Table 1.

### BRIEF DESCRIPTION OF THE DRAWINGS

FIG. 1 is a flow chart of the subscriber sign-up process.

FIG. 2 is a flow chart of an example of the inspection and service tracking functions.

FIG. 3 is flow chart of an example of the healthcare services tracking function.

FIG. 4 is a flow chart of an example of the personnel type tracking function.

FIG. 5 is a flow chart of an example of the check-in/check-out tracking functions.

FIG. 6 is a flow chart of an example of inspection tracking functions.

FIG. 7 is a flow chart of an example of mobile application used in inspection tracking function.

FIG. 8 is a flow chart of an example of using the mobile application to transmit barcode and employee entered data.

FIG. 9 is a flow chart of an example of the personnel tracking function.

FIG. 10 is a flow chart example of the check-in/check-out functions.

### DETAILED DESCRIPTION

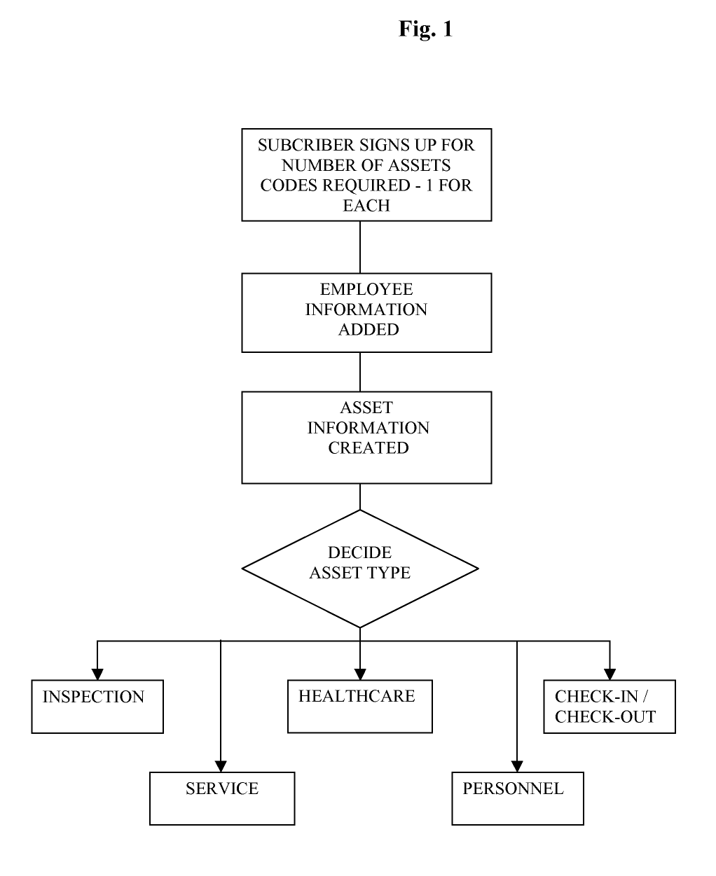

Turning to FIG. 1, the subscriber to the system and method of asset tracking signs up for a number of assets codes required, with one code for each asset. The employee information is added and the asset information is created. The asset type is determined based on the asset function. Examples include inspections, service schedules, healthcare (patient monitoring), personnel tracking, and check-in/check out of equipment.

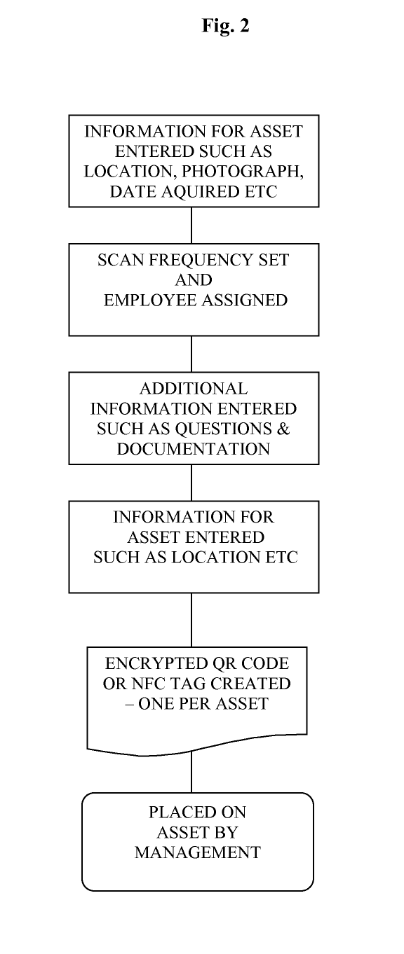

Turning to FIG. 2, the customer has selected inspection and servicing as the asset function and a piece of equipment as the asset. The information for the asset is entered such as a location, photograph or date acquired, etc. The scan frequency is set and an employee is assigned to the asset tracking function. Any additional information such as questions to be answered during the servicing or inspection as well as required documentation of the service or inspection by employee can be entered. The information for the asset is entered, such as the location. An encrypted, geo-coded tag, such as a QR code or NFC tag is created with one tag per asset. The tag is then placed on the asset by management or other predetermined individual.

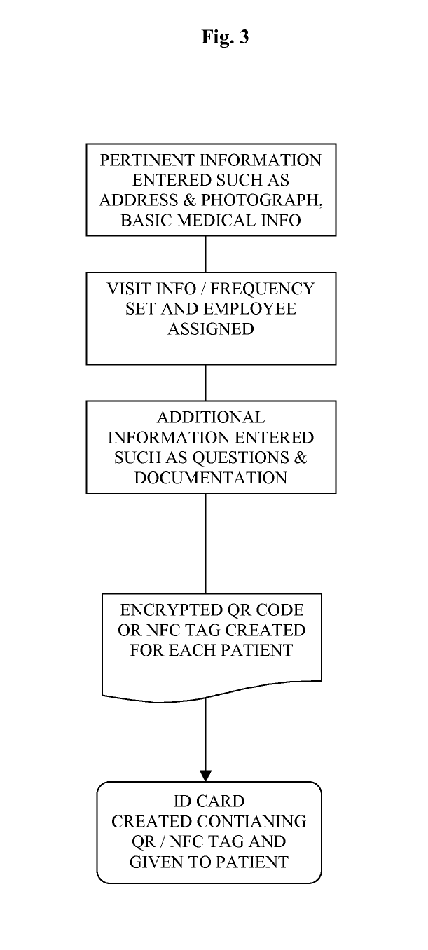

Turning to FIG. 3, the customer has selected healthcare patient monitoring as the asset function and the patient as the asset. The pertinent information of the patient is entered such as address, photograph and basic medical information. The visit information, frequency of visits and the employee assigned to the patient are entered. Any additional information such as questions to be answered during the patient visit as well as required documentation of the visit by employee can be entered. The information for the asset is entered, such as the patient. An encrypted, geo-coded tag, such as a QR code or NFC tag is created with one tag per patient. The tag is then placed on an ID card and given to the patient.

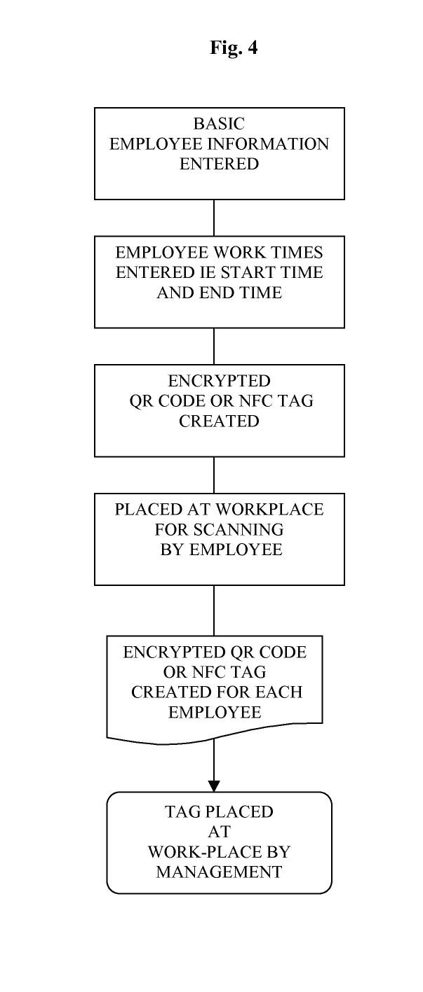

Turning to FIG. 4, the customer has selected personnel tracking as the asset function and the worksite as the asset. The basic employee information is entered. The employee work times are entered, i.e. the start time and end time of the employee shift. An encrypted, geo-coded tag, such as a QR or NFC tag is created. The tag is then placed at the worksite and must be scanned by the employee, with one tag created for each employee.

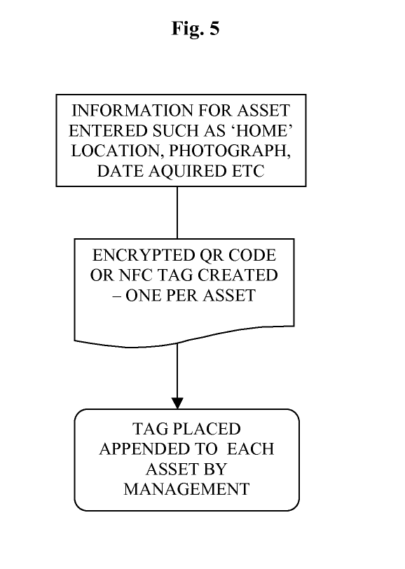

Turning to FIG. 5, the customer has selected the check-in/check-out as the asset function and a piece of equipment as the asset. The information of the asset is entered, such as home location, photograph, date acquired, etc. An encrypted, geo-coded tag, such as a QR or NFC tag is created. The tag is then attached to the asset and must be scanned by the employee when the equipment is checked in or out.

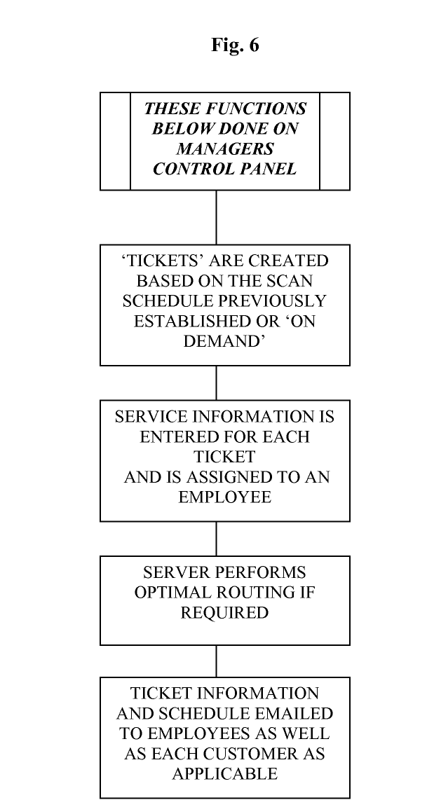

Turning to FIG. 6, the customer has a managers control panel for the service and inspection asset function that allows them to create tickets based on the scan schedule that has been previously established as well as on demand. The service information is entered for each ticket and assigned to an employee. The cloud based server can perform optimal routing of the tickets to employees if required. The ticket information and schedule for service/inspection is emailed to employees as well as the customer(s) as applicable.

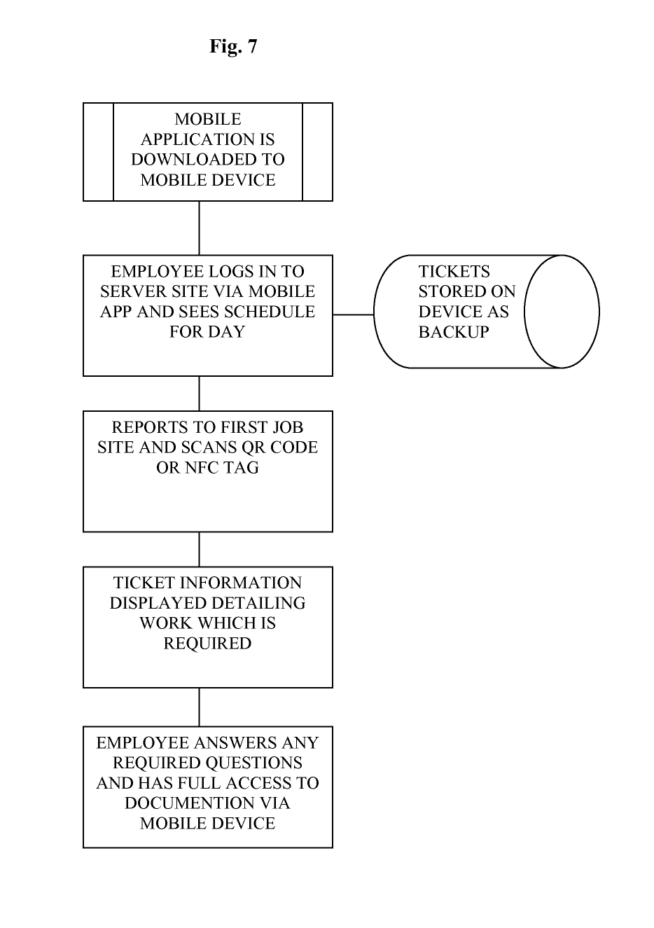

Turning to FIG. 7, the employee is using the mobile application of the present invention by downloading to their mobile device for the service and/or inspection asset function and a piece of equipment or scheduled activity as the asset. The employee logs into the server site via the mobile application and sees their schedule for the day. The tickets can be stored directly on the mobile device as a back up in case they lose contact with the server during the day. The employee reports to the first job site and scans the tag, which will display ticket information on their mobile device showing which service or inspection activity is required. The employee answers any required questions, upload any required documentation and has full access to previously entered documentation via the mobile device.

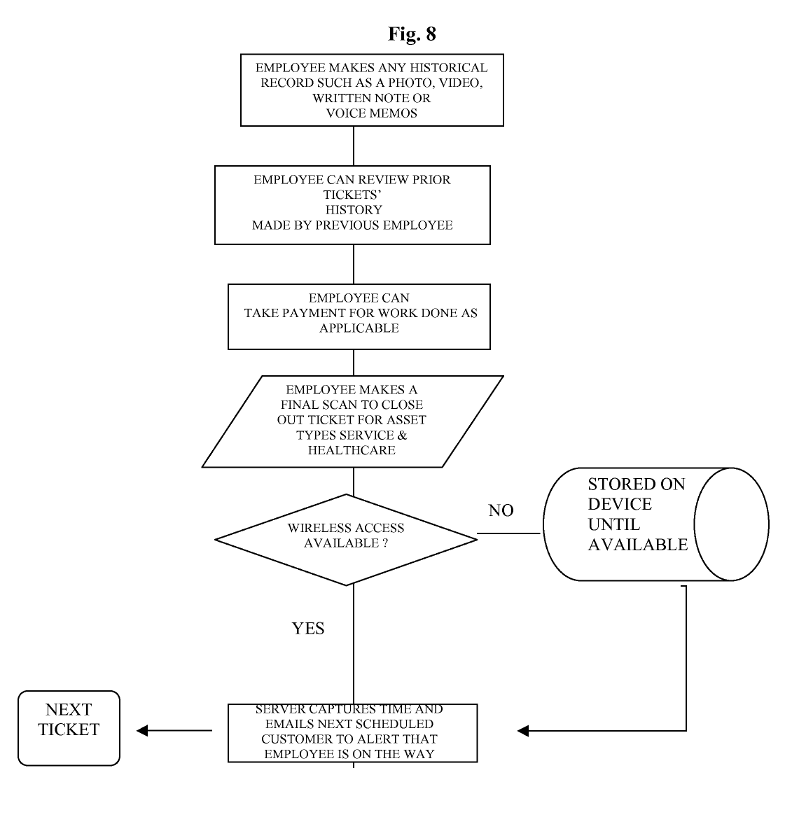

Turning to FIG. 8, the employee is using the mobile device and mobile application for the patient monitoring function with the patient as the asset. After performing designated tasks for patient monitoring and scanning the patient ID tag accordingly, the employee can make any historical record such as a photo, video, written note or voice memos in the mobile device and mobile application. The employee can review any prior tickets' history made by any previous employee. Additionally, the employee can take payment for work done using payment applications on the mobile device that are well known in the prior art. The employee will then make a final scan of the patient's ID card to close out the ticket for healthcare monitoring functions. If wireless access is available, the server captures the time and emails the next scheduled customer alert that the employee is on their way. If the wireless connection is not available, the information is stored on the mobile device until it is able to connect with the server.

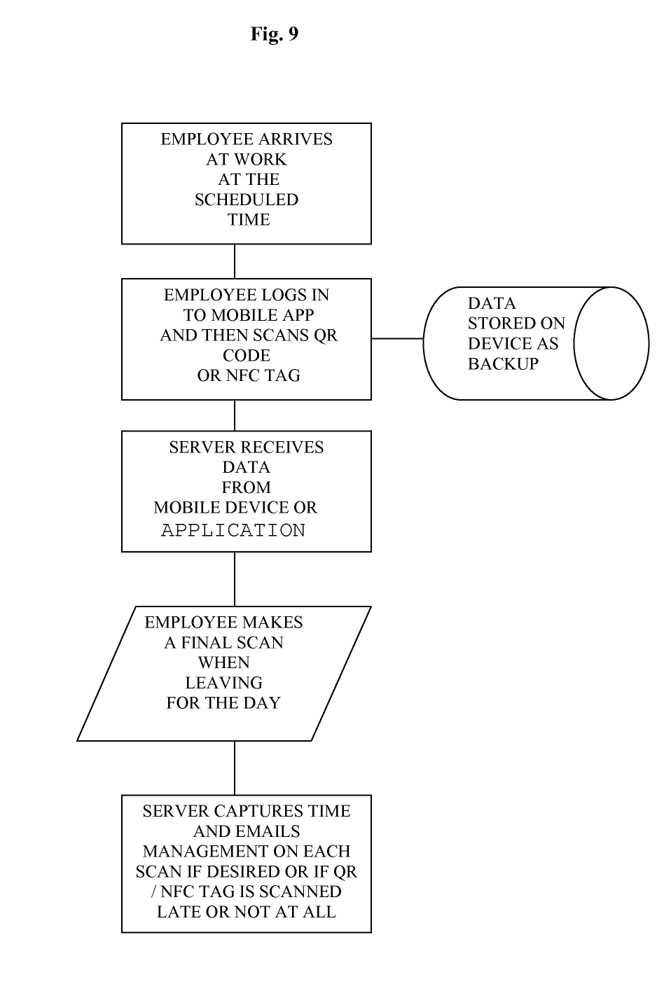

Turning to FIG. 9, the employee is using the mobile device and mobile application for personnel tracking as the asset function with the worksite as the asset. The employee arrives at work, presumably at the scheduled time, and logs into the mobile application then scans the tag. The data is stored in the mobile device as a back up in case the server cannot be accessed at that time. The server receives the data from the mobile device or mobile application. The employee makes a final scan of the tag when leaving for the day. The server captures time of scans and emails predetermined recipients, such as management, on each scan (if desired) or also generates an alert if the tag is scanned late or not scanned at all.

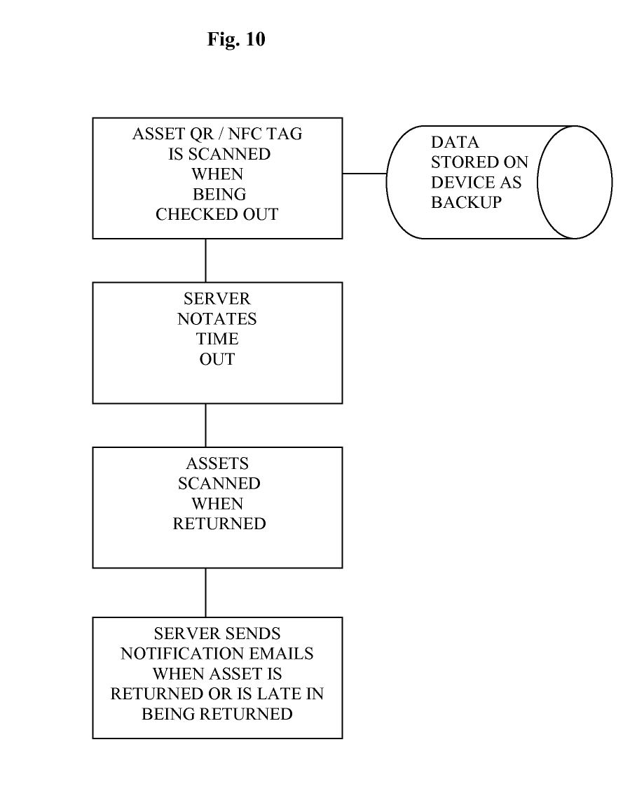

Turning to FIG. 10, the employee scans the asset tag of the piece of equipment when it is being checked out and the data is stored on the device as a back up in case the server cannot be accessed at that time. The server notates the time out. The asset tag of the piece of equipment is scanned when it is checked back in and the server sends an email notification to the predetermined recipient when the asset is returned or if it is late in being returned.

By using the mobile application, which can be preloaded on the mobile device, additional functionality can be incorporated depending on the functionality of the code as chosen when the asset was being created. These additional functionalities include but are not limited to: (1) ability for the management to provide for a services of questions which need to be answered by the employee doing the inspection, such as “What is the temperature or pressure?” and “What is the patient's blood pressure and demeanor”; (2) accessing up to date documentation via the mobile device such as schematics, user guides or forms; (3) ability for the employee or assigned person to enter notes of various kinds relative to each specific asset as needed such as photographs, voice memos, videos, and written notes; (4) ability to review prior history information as to previous services and access notes; (5) ability to accept payment from the customer where necessary; and (6) enable company management or supervisors to communicate directly with employee and/or allow for employee to employee communication.

Companies in any industry can manage the prescribed servicing and routine inspection maintenance of their critical assets that, if not carried out on a timely basis, could jeopardize the viability of their ongoing operations, such as Hotels, Attractions, Security Companies, Manufacturers and Municipalities. Questions such as follows can easily be answered:

“When was the last generator checked, and by whom?”
“Was the store opened up on time for business?”
“Did the restocking clerk miss one of the vending machines?”
“Were all four sides of a vacant house checked or just the front?”
“Were my pets fed on time while I was away on vacation?”

Further examples of how the present invention may be utilized according to asset and function are set forth below in Table 1, which in no way limits the scope of the invention to such examples.

TABLE 1

| Industry | Asset | Function | Example |
|---|---|---|---|
| Service Maintenance | Piece of Equipment | Inspection and Servicing | monitoring their field |
| Companies | | | technicians, helping |
| | | | to ensure that they are |
| | | | showing up for |
| | | | appointments on a timely |
| | | | basis, and alerting both |
| | | | management and their |
| | | | customers of any potential |
| | | | delays via emails or text |
| | | | messaging, helping to |
| | | | protect and enhance the |
| | | | company's reputation |
| Healthcare providers | Patient | Patient Monitoring | ensuring that patient visits |
| | | | are scheduled and |
| | | | maintained on a timely |
| | | | basis, providing |
| | | | independent verification to |
| | | | satisfy compliance |
| | | | protocols for all levels of |
| | | | care, mitigating audits for |
| | | | improper questionable |
| | | | practices |
| Construction Companies | Worksite | Personnel Tracking | confirming that critical |
| | | | staff and sub-contractors |
| | | | are reporting to various job |
| | | | sites when they should |
| Agribusiness | Assigned Activity | Activity Tracking | management can receive |
| | | | independent verification |
| | | | that critical operations are |
| | | | being carried out by all |
| | | | levels of staff on a timely |
| | | | basis, thus enhancing |
| | | | productivity |
| Municipalities | Equipment | Inspection Tracking | ensuring that public works |
| | | | and public facilities are |
| | | | being inspected when they |
| | | | should, to minimize |
| | | | potential hazards and |
| | | | downtime, resulting in |
| | | | increased cost |
| Home Management | Person | Location Tracking | ensuring that children have |
| | | | arrived home or to other |
| | | | locations safely |
| Elections | Worksite | Personnel Tracking | confirming that election |
| | | | personnel are where they |
| | | | are supposed to be, at the |
| | | | correct time to account for |
| | | | every single ballet box in |
| | | | every electoral precinct |
| Hospitality | Equipment | Service Tracking | ensuring that vital |
| | | | equipment is being |
| | | | maintained on a pre- |
| | | | established maintenance |
| | | | schedule and to assigned |
| | | | individuals, thereby |
| | | | reducing the impact of |
| | | | unprofitable downtime |
| Transit | Person | Location Tracking | ensuring that person with |
| | | | coded tag is at the right |
| | | | place at the right time, such |
| | | | as kids on a school bus or |
| | | | senior citizens pickups |
| Property Management | House | Inspection Tracking | ensure that property is |
| | | | being monitored on a |
| | | | timely basis |
| Retail Business | Business | Activity Tracking | confirm that employees are |
| | | | arriving on time and not |
| | | | closing store too early |
| Vending Management | Equipment | Service Tracking | ensure that vending |
| | | | machines don't go days or |
| | | | weeks without being |
| | | | check, thus losing out on |
| | | | valuable sales |
| Pet Sitting | Animal | Activity Tracking | ensure that pet is being |
| | | | looked after at appropriate |
| | | | intervals while on vacation |

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A system for asset management comprising:
a code assigned to an asset;
an encrypted, geo-coded barcode;
a mobile device for scanning and transmitting data from the encrypted, geo-coded barcode; and
a cloud based computer server system that receives barcode scan data from the mobile device and generates log of barcode scans.

2. The system of claim 1 further comprising a message alert function.

3. The system of claim 2 further comprising a predetermined tolerance time period wherein the code assigned to the asset is made inactive until the barcode is scanned within the predetermined tolerance time period.

4. The system of claim 3 wherein if the barcode is scanned outside the predetermined tolerance time period, the message alert function is activated.

5. The system of claim 1 further comprising a mobile application.

6. The system of claim 5 further comprising a software application wherein the mobile application may be integrated with software application to generate reports from the log of barcode scans.

7. The system of claim 5 wherein the mobile application stores the log of barcode scans independent from the cloud based server system.

8. The system of claim 5 wherein if the mobile device is unable to transmit the barcode scan to the cloud based computer server system, the mobile application captures the barcode scan and stores it for later transmission to the cloud based computer server system.

9. The system of claim 1 wherein the code assigned to an asset is based on the function of the asset.

10. The system of claim 1 wherein the asset is selected from the group comprising a piece of equipment, a person, a worksite, or an assigned activity.

11. The system of claim 1 where in the encrypted, geo-coded barcode is selected from the group comprising a near field communication (NFC) tag, a quick response (QR) tag, radio-frequency identification tag (RFID) or other tag suitable for encryption and subsequent scanning.

12. A method for asset management comprising:
assigning a code to an asset;
attaching an encrypted, geo-coded barcode to asset;
scanning the encrypted, geo-coded barcode with a mobile device;
transmitting barcode scan information from mobile device to cloud based computer server system; and
generating log of barcode scans.

13. The method of claim 12 further comprising generation of alert messages to predetermined recipients.

14. The method of claim 13 further comprising establishing a predetermined tolerance time period wherein if the encrypted, geo-coded barcode is not scanned with the mobile device within the predetermined tolerance time period, an alert message is generated to a predetermined recipient.

15. The method of claim 12 further comprising accessing a mobile application on the mobile device to capture and store the log of barcode scans.

16. The method of claim 15 further comprising integrating the mobile application with a software application to generate reports from the log of barcode scans.

17. The method of claim 15 wherein the mobile application stores the log of barcode scans independent from the cloud based server system.

18. The method of claim 12 wherein the code is assigned to an asset based on the function of the asset.

19. The method of claim 12 wherein the asset is selected from the group comprising a piece of equipment, a person, a worksite, or an assigned activity.

20. The method of claim 12 wherein the encrypted, geo-coded barcode is selected from the group comprising a near field communication (NFC) tag, a quick response (QR) tag, radio-frequency identification tag (RFID) or other tag suitable for encryption and subsequent scanning.
